(19) United States
(12) Patent Application Publication
(10) Pub. No.: US 2014/0164203 A1
(43) Pub. Date: Jun. 12, 2014

(54) METHOD AND SYSTEM FOR EVALUATING KEY PRICE LEVELS OF TRADABLE INSTRUMENTS

(71) Applicant: Robert Balon, Winnetka, IL (US)

(72) Inventor: Robert Balon, Winnetka, IL (US)

(21) Appl. No.: 13/711,590

(22) Filed: Dec. 11, 2012

(51) Int. Cl. G06Q 40/00

(52) U.S. Cl. CPC G06Q 40/04
USPC 705/37

(57) ABSTRACT

The present invention provides a method and system for evaluating key price levels, highlighted by the actions of professional money, for a tradable instrument in a financial marketplace, such as a commodity or security. The method provides a process for determining statistically meaningful surges in the mathematical product of price range and trading volume, and associating the statistically meaningful surges in the product with specific price levels. The system provides a process operating on a computer system, a commonly available trading platform or data processor, and software algorithms, operable in combination to graphically represent statistically meaningful surges in the combination of price range and trading volume.

### RELATED APPLICATION—PRIORITY CLAIM

This application claims the benefit of U.S. Provisional Patent Application No. 61/569,262, entitled “METHOD AND SYSTEM FOR EVALUATING KEY PRICE LEVELS OF TRADABLE INSTRUMENTS,” filed on Dec. 11, 2011. This application claims the benefit of the previously filed application under 35 U.S.C. §119.

### TECHNICAL FIELD

This application relates to a method and system for evaluating the combination of modulated price range and trading volume information for a tradable instrument in a financial marketplace, such as a commodity or security.

### BACKGROUND

There are many technical analysis tools that allow traders to evaluate the price movements of tradable instruments in financial marketplaces, such as commodities, stocks, bonds, futures, currencies, indexes, and others. Many of these tools are indicators that rely on either price or volume.

However, few indicators combine both price and volume to highlight meaningful price levels. Furthermore, conventional indicators do not highlight price movement in relation to statistically meaningful surges in the combined product of price range and trading volume information. These surges, as described in this invention, can highlight the relative magnitude of price movements for specific time intervals in relation to the price movements associated with preceding or following time intervals.

It is widely accepted by experienced traders that surges in trading volume are not possible without the heavy participation of professional money, or the so called smart money. Professional money represents the collective perceptions of financial institutions, hedge funds, corporations, or other large volume participants. Although many traders recognize the importance of identifying the actions of professional money in a marketplace, it can be difficult for traders to identify these actions.

Multiplying price range by trading volume amplifies the magnitude of a price movement for time intervals in relation to one another. There are four primary examples of insights that traders can glean from evaluating the combination of price range and trading volume for any given time interval.

### Example 1

Large price movements accompanied by small trading volumes can suggest professional money is not participating in the price movement.

### Example 2

Small price movements accompanied by large trading volumes can suggest professional money is not succeeding in generating further price movement for the effort that is being applied in the marketplace.

### Example 3

Large price movements accompanied by large trading volumes can suggest professional money is participating in a price movement. This price movement can be further meaningful if it breaks previously established support or resistance levels.

### Example 4

Small price movements accompanied by small trading volumes can suggest either professional money is not heavily participating in price movement, or buyers or sellers have potentially exhausted the current trend associated with new price discovery or new price movement.

Surges in the combination of price range and trading volume, when related to the price levels that accompany these surges, can suggest key price levels that are considered important by professional money. In this case, importance is implied by the elevated number of shares, contracts, or lots that were traded, or exchanged hands, among heavy participants.

The extent to which price movement accompanied the elevated trading volume can provide further insight whether the professional participation may signal the reversal of a trend, or a breakout for price discovery to a new price level. Furthermore, price movements associated with subsequent time intervals after the surge can also be useful in suggesting whether the high intensity price levels considered important by professional money are being either respected or deliberately broken as support or resistance levels.

### SUMMARY OF INVENTION

The present invention provides a method and system for evaluating key price levels, based on determining statistically meaningful surges in the mathematical product of price range and trading volume, and associating the statistically meaningful surges in the product with specific price levels.

One aspect of the invention includes: a processor-implemented method for determining by a data processor modulated price information for a plurality of time intervals in a selected trading period; determining by the data processor modulated trading volume information for a plurality of time intervals in the trading period; calculating by the data-processor the mathematical product of the modulated price range and trading volume information for a plurality of time intervals in the trading period so as to identify statistically meaningful surges in the product; identifying by the data processor a threshold that is used to highlight statistically meaningful surges in the product of modulated price range and trading volume information; identifying by the data processor the modulated price information for one or more time intervals that is associated with statistically meaningful surges in the product of modulated price range and trading volume information based on the threshold; and displaying on a data display the modulated price information, the product of modulated price range and trading volume information, and the price levels that are associated with statistically meaningful surges in the product of modulated price range and trading volume information based on the threshold.

Another aspect of the invention includes a processor-implemented method for determining by the data processor a threshold that is used to identify the statistically meaningful surges in the product of the modulated price range and trading volume information using an arithmetic multiple of the moving average of the product.

Another aspect of the invention includes a processor-implemented method for determining by the data processor a threshold that is used to identify the statistically meaningful surges in the product of the modulated price range and trading volume information using an arithmetic multiple of the standard deviation of the product.

Another aspect of the invention includes a system for implementing the previously described method comprising: a process operating on a computer system, a commonly available trading platform or data processor, and a software algorithm, operable in combination to graphically represent statistically meaningful surges in the combination of price range and trading volume.

### BRIEF DESCRIPTION OF DRAWINGS

The appended drawings illustrate embodiments of the invention. However, the present invention is not limited to the precise arrangements or instrumentalities shown. The drawings should not be construed as restricting the spirit or scope of the invention in any way. The drawings show examples using one-minute price charts during a one day trading period. However, other embodiments of the invention may use a variety of price bar intervals or trading periods.

In the drawings, like numerals represent like elements. In addition, the first digit in the three-digit reference numerals refer to the figure in which the referenced element first appears.

FIG. 1 shows a current method and system embodiment of the invention, including a data feed, computer system, trading platform or data processor, software algorithm, and data display.

FIG. 2 is a graph of modulated price and trading volume information in one-minute intervals during a one-day trading period.

FIG. 3 is the graph of FIG. 2, with the product of said modulated price range and trading volume information shown as part of this invention, including a multiple of the moving average of said product used as a threshold.

FIG. 4 is the graph of FIG. 2, with the product of said modulated price range and trading volume information shown as part of this invention, including a multiple of the standard deviation of said product used as a threshold.

FIG. 5 is a flowchart showing a process of evaluating statistically meaningful surges in the combination of modulated price range and trading volume.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The present invention provides a method and system for evaluating key price levels, based on determining statistically meaningful surges in the mathematical product of price range and trading volume, and associating the statistically meaningful surges in the product with specific price levels.

There are many technical analysis tools that allow traders to evaluate the price movements of tradable instruments in financial marketplaces, such as commodities, stocks, bonds, futures, currencies, indexes, and others. Many of these tools are indicators that rely on either price or volume.

However, few indicators combine both price and volume to highlight meaningful price levels. Furthermore, conventional indicators do not highlight price movement in relation to statistically meaningful surges in the combined product of price range and trading volume information. These surges, as described in this invention, can highlight the relative magnitude of price movements for specific time intervals in relation to the price movements associated with preceding or following time intervals.

It is widely accepted by experienced traders that surges in trading volume are not possible without the heavy participation of professional money, or the so called smart money. Professional money represents the collective perceptions of financial institutions, hedge funds, corporations, or other large volume participants. Although many traders recognize the importance of identifying the actions of professional money in a marketplace, it can be difficult for traders to identify these actions.

This invention multiplies price range and trading volume to amplify the magnitude of specific price movements for specific time intervals. This invention identifies statistically meaningful surges in the mathematical product of said price and trading volume. Furthermore, this invention identifies key price levels by highlighting the specific price candles, or price bars, associated with the statistically meaningful surges of said product of price range and trading volume. To assist traders with assessing the price movements of large volume participants in the marketplace, this invention also highlights said price candles based on increasing or decreasing price movements associated with the statistically meaningful surges of said product of price range and trading volume.

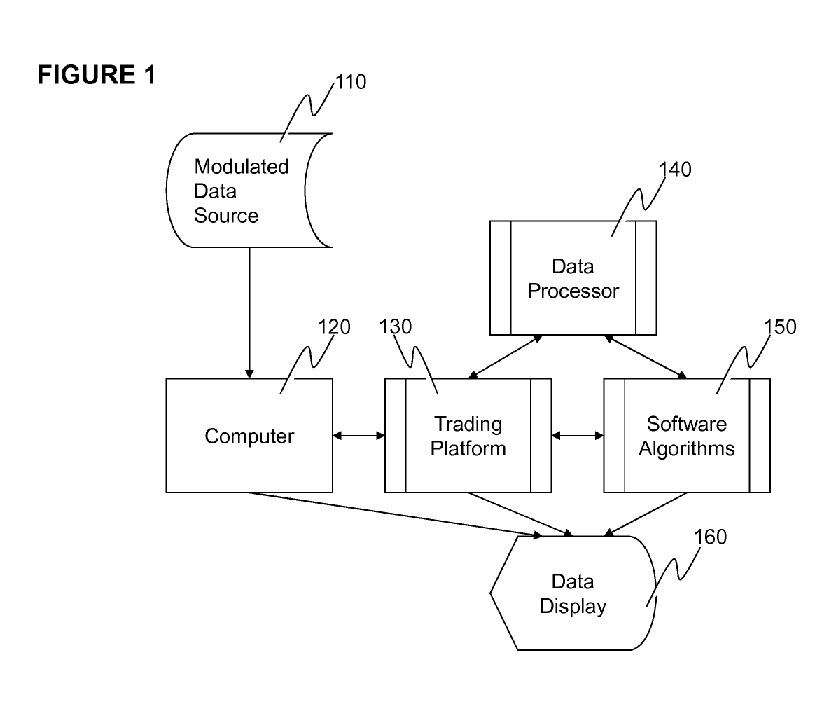

In FIG. 1, modulated price range and trading volume data are obtained from a Modulated Data Source 110. The Modulated Data Source can be obtained from a data feed supplied by a brokerage firm or dealer in tradable instruments such as such as commodities, stocks, bonds, futures, currencies, indexes, or others. A trader typically uses a computer 120 to connect to financial marketplaces and evaluate potential trading setups using a commonly available trading platform 130. The trading platform can be any one or more of several available from brokers or third party vendors. The trading platform commonly includes an embedded data processor 140 as well as the ability for traders to add custom developed software algorithms 150. The computer is connected to a data display 160. The data display presents information to the trader based on data processed by the trading platform as well as the custom software algorithms described in this invention.

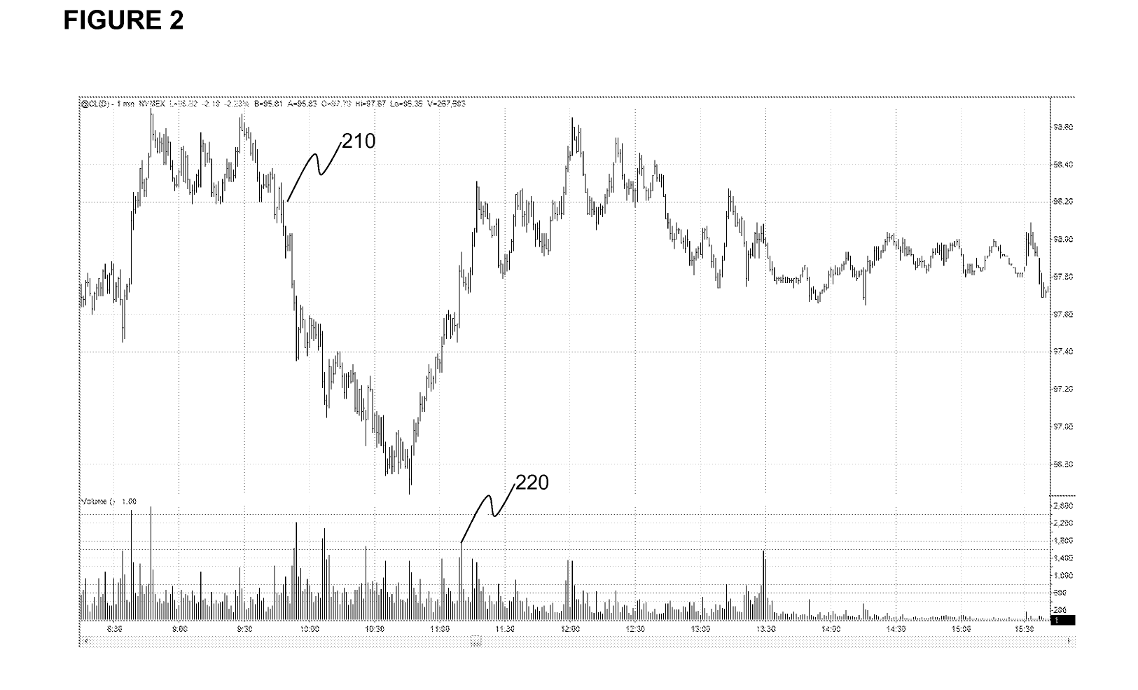

FIG. 2 shows a traditional price chart 210 and trading volume 220 in modulated time intervals. As an example, FIG. 2 shows a price chart for oil futures using one-minute price candles for one trading day. However, other embodiments of this invention may use a variety of trading instruments, price intervals, or trading periods.

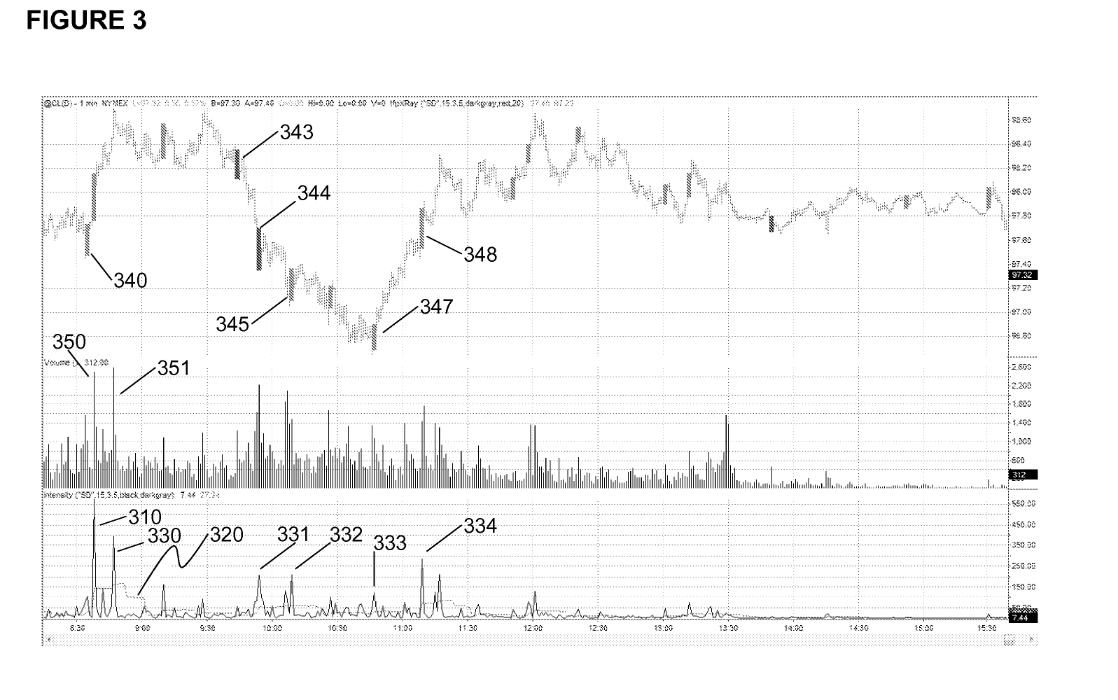

FIG. 3 shows the same price chart and trading volume from FIG. 2, but also includes an Intensity Indicator 310 and highlighted key price levels such as 340. The Intensity Indicator may be referred to as the Price Range Volume Intensity™, or PRVI™. The Intensity Indicator may also be referred to as tfpIntensity™ or tfpXRay™. In this example, the Intensity Indicator 310 is based on the mathematical product of the modulated price range data in 210 and the modulated trading volume in 220.

Formula for the Intensity Indicator:

Intensity=Candle Range×Volume

Candle Range is the height, or price movement associated with a price candle. In the current embodiment, Candle Range is based on the difference between the open and close prices of each price candle:

Candle Range=Absolute Value (Close−Open)

In other embodiments, Candle Range can be based on the high and low prices of each price candle:

Candle Range=Absolute Value (High−Low)

Traders using this invention can specify a parameter that determines whether Candle Range is based on the open/close or high/low of each price candle.

Reference 320 shows an Intensity Basis indicator. The Intensity Basis is determined by calculating either the moving average or the standard deviation of 310. Traders using this invention can specify a parameter that determines whether the Intensity Basis is calculated using a moving average or standard deviation.

Formula for the Intensity Basis Indicator:

Basis=Moving Average (Intensity, Length)

where Length is equal to the number of time intervals to use in calculating the moving average.

In other embodiments, the Intensity Basis can also be based on the standard deviation of the Intensity Indicator:

Basis=Standard Deviation (Intensity, Length)

where Length is equal to the number of time intervals to use in calculating the standard deviation.

Reference 340 shows how the invention highlights a price candle when the Intensity Indicator demonstrates a spike that exceeds a Basis Trigger Threshold. The Basis Trigger Threshold is the Intensity Basis multiplied by a trader specified factor.

Formula for the Basis Trigger Threshold:

Basis Trigger Threshold=Basis×Factor

where the factor default value in this invention is 3.5, but can be set to any value by a trader

The invention highlights key price candles if triggered by Intensity Indicator values that exceed the Basis Trigger Threshold. Only price candles that are associated with the statistically meaningful surges in the Intensity Indicator are highlighted. The invention deemphasizes other price candles to further highlight the price candles associated with statistically meaning Intensity Indicator surges.

By highlighting price candles such as in 340, this invention highlights key price movements associated with statistically meaningful surges in the Intensity Indicator, or said product of price range and trading volume. This can help traders visualize meaningful price levels that are supported by a surge in trading volume. As described previously, this can be interpreted as price levels that are deemed to be important to professional money.

Price candles highlighted by this invention are price levels associated with surges in trading activity. Traders can visualize the relative importance of these price levels by evaluating the height of the intensity surge—the taller the intensity spike, the more important the price level. By highlighting only the price candles associated with Intensity Indicator surges, while deemphasizing all other price candles, it is as if this invention provides a form of market generated X-Ray vision to traders for the price levels deemed important to professional money, or large volume participants.

References 350 and 351 illustrate a unique feature provided by this invention to traders, rather than relying on volume alone. In this example, the volume spikes in 350 and 351 are increasing. However, the Intensity Indicator spikes associated with these same time intervals 310 and 330 are decreasing. Although trading volume has increased, Intensity Indicator spike 330 implies that the increase in trading volume is not supported by a commensurate movement in price. Because intensity spike 330 failed to exceed the Basis Trigger Threshold, no price candle is highlighted by the invention.

Another feature of this invention is that highlighted price candles can be colored and emphasized based on a trader's preferences. For example, price candle 340 is an up bar, where the closing price exceeds the opening price of the candle. In this example, highlighted up bars are colored gray by the invention, but can be optionally emphasized with any color based trader preferences. Price candle 343 is a down bar, where the opening price exceeds the closing price of the candle. In this example, highlighted down bars are colored dark red by the invention, but can be optionally emphasized with any color based on trader preferences.

When price movement in the candles that follow price candle 340 failed to break below the lows of price candle 340, this can potentially be interpreted by traders as a bullish signal. When price movement in the candles that follow price candle 343 failed to break above the highs of price candle 343, this can potentially be interpreted by traders as a bearish signal. This allows traders to position themselves for anticipated future price movement while placing protective stops and managing risk based on the highs or lows of key price levels as deemed important by market generated information.

Price candles highlighted by the invention in 344, 345, 347, and 348 are associated with Intensity Indicator spike surges that exceed the Basis Trigger Threshold in 331, 332, 333, and 334, respectively.

Of course, these are general guidelines and, as with any trading analysis tool, there are no guarantees. Past performance or price history is by no means a guarantee for future results. Furthermore, risk management and protective stops are prudent. The development of trading rules and guidelines to utilize this invention is beyond the scope of the invention itself. This invention alone does not tell traders how to trade. Considerable experience, skill, and understanding of market dynamics are essential for any trader, regardless of which tools are deployed or how they are used. However, there are a variety of managed risk trading rules and setups that can be developed based on the features of this invention.

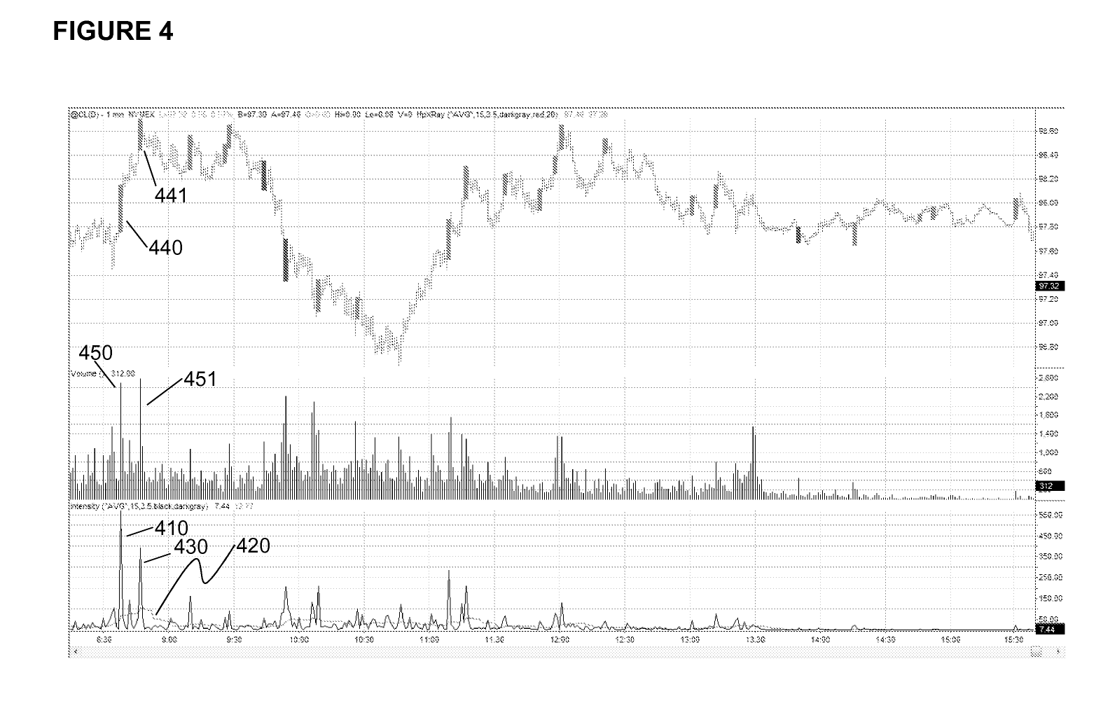

FIG. 4 is the same as FIG. 3, however in this example the reference 420 highlights the Intensity Basis as calculated based on a moving average. Using a moving average rather than standard deviation allows a trader to achieve different degrees of sensitivity afforded by the invention as it highlights key price candles.

In this example, intensity spikes 410 and 430 are identical to 310 and 330. However, since a moving average is used, a different value is determined by the invention for Intensity Basis 420. Consequently, price candle 441 is highlighted when a moving average is specified for the basis, whereas this same price candle was not highlighted by the invention when a standard deviation was specified for the basis in FIG. 3. Volume bars 450 and 451 are identical to 350 and 351.

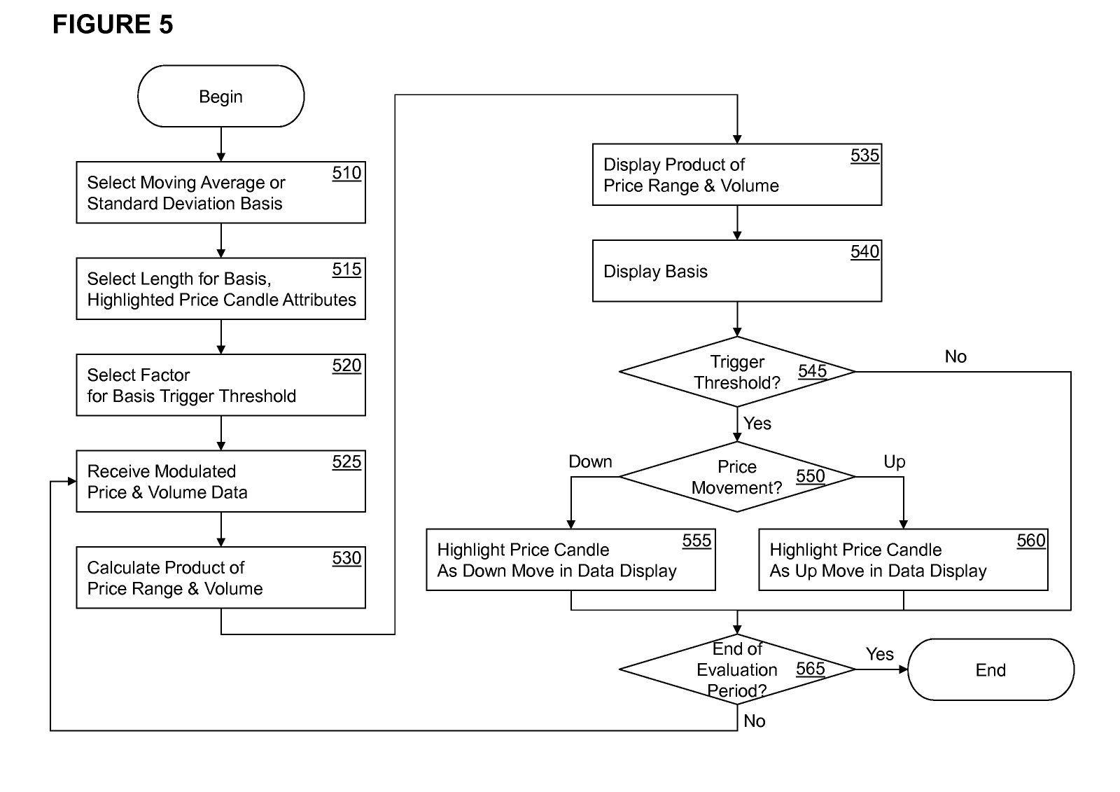

FIG. 5 is a flow chart that illustrates the process by which key price levels can be evaluated, enabled by this invention. In 510, a trader can select whether the Intensity Basis is calculated using a moving average or standard deviation.

In 515, a trader can specify the Length, or number of prior time intervals that are used to calculate said moving average or standard deviation. In 515, a trader can also specify the attributes for key price candles that are to be highlighted by this invention. Attributes are not limited to, but can include, such elements as the color or width of highlighted price candles. In one embodiment, this invention emphasizes, or highlights, key price candles triggered by the invention, while deemphasizing price candles that are not triggered by the invention.

In 520, a trader can specify the factor to be used for the Basis Trigger Threshold.

In 525, modulated price and trading volume data is received from a commonly available trading platform, enabled by a data source. The mathematical product of price range and trading volume is calculated in 530.

The product of price range and volume date, or Intensity Indicator, is displayed in 535. The Intensity Basis is displayed in 540. In 545, the invention determines if the Intensity Indicator spike for each modulated price and volume interval exceeds the Basis Trigger Threshold. If yes, then in 550, the invention determines the direction of the price movement for the associated price candle. If the price movement is up, in 555 the invention highlights the associated price candle based on trader specified attributes in 515, such as the color green or a different width. If the price movement is down, in 560 the invention highlights the associated price candle based on trader specified attributes in 515, such as the color red or a different width.

If in 545, the invention determines that the Intensity Indicator spike for a modulated price and volume interval does not exceed the Basis Trigger Threshold, then in 565 the invention continues to the next step and determines if there is more modulated price and volume data. If it is the end of the evaluation period and no further modulated data is available, processing ends. If more modulated data exists, then the invention continues processing with 525.

As is apparent to those skilled in the art in light of the foregoing disclosure, many alterations, arrangements, or instrumentalities are possible in the practice of this invention without departing from the spirit or scope thereof.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. A processor-implemented method for determining by a data processor modulated price information for a plurality of time intervals in a selected trading period, comprising;
(a) determining by the data processor modulated trading volume information for a plurality of time intervals in the trading period;
(b) calculating by the data-processor the mathematical product of the modulated price range and trading volume information for a plurality of time intervals in the trading period so as to identify statistically meaningful surges in the product;
(c) identifying by the data processor a threshold that is used to highlight statistically meaningful surges in the product of modulated price range and trading volume information;
(d) identifying by the data processor the modulated price information for one or more time intervals that is associated with statistically meaningful surges in the product of modulated price range and trading volume information based on the threshold; and
(e) displaying on a data display the modulated price information, the product of modulated price range and trading volume information, and the price levels that are associated with statistically meaningful surges in the product of modulated price range and trading volume information based on the threshold.

2. The method as defined in claim 1 wherein said threshold of said product of the modulated price range and trading volume information uses an arithmetic multiple of the moving average of said product.

3. The method as defined in claim 1 wherein said threshold of said product of the modulated price range and trading volume information uses an arithmetic multiple of the standard deviation of said product.

4. A system for implementing the method described in claim 1 comprising a process operating on a computer system, a commonly available trading platform or data processor, and a software algorithm, operable in combination to graphically represent statistically meaningful surges in the combination of price range and trading volume.
